(19) United States
(12) Patent Application Publication
(10) Pub. No.: US 2025/0378842 A1
(43) Pub. Date: Dec. 11, 2025

(54) ECHO CANCELLATION

(71) Applicant: Nokia Technologies Oy, Espoo (FI)

(72) Inventors: Wouter LANNEER, Antwerp (BE); Sampo VESA, Espoo (FI)

(21) Appl. No.: 19/226,448

(22) Filed: Jun. 3, 2025

(30) Foreign Application Priority Data
Jun. 11, 2024 (GB) 2408307.3

(51) Int. Cl. G10L 21/0208

(52) U.S. Cl. CPC G10L 21/0208; G10L 2021/02082

(57) ABSTRACT

The present specification describes an apparatus for multi-channel acoustic echo cancellation comprising: means for determining whether a received audio signal is associated with a single channel classification or a multi-channel classification; means for determining whether the received audio signal is associated with a different classification than a previous classification; means for switching adaptive filters for the received audio signal from a first adaptive filter to a second adaptive filter, based on the determination that the received audio signal is associated with a different classification than the previous classification; and means for applying the second adaptive filter to the received audio signal, wherein the means for applying the second adaptive filter is configured to enable reduction of echo from a captured signal.

### FIELD

The present specification relates to acoustic echo cancellation, particularly to multi-channel echo cancellation.

### BACKGROUND

Some implementations for acoustic echo cancellation. There remains a need for improvement in the field for reduction of echo for multi-channel playback signals.

### SUMMARY

In a first aspect, this specification provides an apparatus for multi-channel acoustic echo cancellation comprising: means for determining whether a received audio signal is associated with a single channel classification or a multi-channel classification; means for determining whether the received audio signal is associated with a different classification than a previous classification; means for switching adaptive filters for the received audio signal from a first adaptive filter to a second adaptive filter, based on the determination that the received audio signal is associated with a different classification than the previous classification; and means for applying the second adaptive filter to the received audio signal, wherein the means for applying the second adaptive filter is configured to enable reduction of echo from a captured signal.

In some examples, the adaptive filters comprise recursive least squares filters.

In some examples, the means for switching comprises determining internal parameters of the second adaptive filter based, at least in part, on the internal parameters of the first adaptive filter.

In some examples, the means for determining whether a received audio signal is associated with a single channel classification or a multi-channel classification comprises: means for determining that the received audio signal is associated with a single channel classification if a condition number is lower than a first threshold; and means for determining that the received audio signal is associated with a multi-channel classification if the condition number is higher than a second threshold; wherein the condition number is calculated based on a correlation matrix associated with the received audio signal.

In some examples, the multi-channel classification indicates a stereo classification, and the single channel classification indicates a mono classification.

In some examples, the means for switching adaptive filters comprises means for switching adaptive filters from a multi-channel adaptive filter to a single channel adaptive filter if the received audio signal is associated with a single channel classification and the previous classification is a multi-channel classification. In some examples, the means for switching adaptive filters from the multi-channel adaptive filter to the single channel adaptive filter further comprises: means for initializing mono filter coefficients by combining one or more channel filters of the multi-channel adaptive filter.

In some examples, the means for switching adaptive filters from the multi-channel adaptive filter to the single channel adaptive filter further comprises: means for determining a first inverse correlation matrix for the single channel adaptive filter based, at least in part, on a second inverse correlation matrix for the multi-channel adaptive filter corresponding to at least one of: at least one of a plurality of channels of the received audio signal; or a reference channel of the plurality of channels of the received audio signal.

In some examples, the first inverse correlation matrix is determined based, at least in part, on a diagonal part of the second inverse correlation matrix for the multi-channel adaptive filter corresponding to the reference channel.

Some examples further comprise means for determining the reference channel based on mixing of a plurality of channels of the received audio signal.

Some examples further comprise means for determining the reference channel based on selecting a channel having a highest energy from a plurality of channels of the received audio signal.

In some examples, the means for switching adaptive filters comprises means for switching adaptive filters from a single channel adaptive filter to a multi-channel adaptive filter if the received audio signal is associated with a multi-channel classification and the previous classification is a single channel classification.

In some examples, the means for switching adaptive filters from the single channel adaptive filter to the multi-channel adaptive filter comprises means for restoring internal parameters relating to the multi-channel adaptive filter from a previous operation for switching adaptive filters from the multi-channel adaptive filter to the single channel adaptive filter.

In some examples, the means for switching adaptive filters from the single channel adaptive filter to the multi-channel adaptive filter comprises means for copying, to each of a plurality of channels of the multi-channel adaptive filter, a filter based on a mono echo filter.

In some examples, the means for switching adaptive filters from the single channel adaptive filter to the multi-channel adaptive filter further comprises means for initializing a multi-channel inverse correlation matrix using a diagonal matrix based on the inverse correlation matrix of the single channel adaptive filter.

In some examples, at least one of the first adaptive filter and the second adaptive filter comprises a frequency-domain adaptive filter.

In some examples, the means for applying the second adaptive filter comprises means for applying a parallel adaptive filter for each frequency sub-band associated with the received audio signal.

The means may comprise: at least one processor; and at least one memory including computer program code, the at least one memory and the computer program code configured, with the at least one processor, to cause the performance of the apparatus.

In a second aspect, this specification describes a method comprising: determining whether a received audio signal is associated with a single channel classification or a multi-channel classification; determining whether the received audio signal is associated with a different classification than a previous classification; switching adaptive filters for the received audio signal from a first adaptive filter to a second adaptive filter, based on the determination that the received audio signal is associated with a different classification than the previous classification; and applying the second adaptive filter to the received audio signal, wherein applying the second adaptive filter is configured to enable reduction of echo from a captured signal.

In some examples, the adaptive filters comprise recursive least squares filters.

In some examples, the switching comprises determining internal parameters of the second adaptive filter based, at least in part, on the internal parameters of the first adaptive filter.

In some examples, determining whether a received audio signal is associated with a single channel classification or a multi-channel classification comprises: determining that the received audio signal is associated with a single channel classification if a condition number is lower than a first threshold; and determining that the received audio signal is associated with a multi-channel classification if the condition number is higher than a second threshold; wherein the condition number is calculated based on a correlation matrix associated with the received audio signal.

In some examples, the multi-channel classification indicates a stereo classification, and the single channel classification indicates a mono classification.

In some examples, switching adaptive filters comprises switching adaptive filters from a multi-channel adaptive filter to a single channel adaptive filter if the received audio signal is associated with a single channel classification and the previous classification is a multi-channel classification. In some examples, switching adaptive filters from the multi-channel adaptive filter to the single channel adaptive filter further comprises: initializing mono filter coefficients by combining one or more channel filters of the multi-channel adaptive filter.

In some examples, switching adaptive filters from the multi-channel adaptive filter to the single channel adaptive filter further comprises: determining a first inverse correlation matrix for the single channel adaptive filter based, at least in part, on a second inverse correlation matrix for the multi-channel adaptive filter corresponding to at least one of: at least one of a plurality of channels of the received audio signal; or a reference channel of the plurality of channels of the received audio signal.

In some examples, the first inverse correlation matrix is determined based, at least in part, on a diagonal part of the second inverse correlation matrix for the multi-channel adaptive filter corresponding to the reference channel.

Some examples further comprise determining the reference channel based on mixing of a plurality of channels of the received audio signal.

Some examples further comprise determining the reference channel based on selecting a channel having a highest energy from a plurality of channels of the received audio signal.

In some examples, switching adaptive filters comprises switching adaptive filters from a single channel adaptive filter to a multi-channel adaptive filter if the received audio signal is associated with a multi-channel classification and the previous classification is a single channel classification.

In some examples, switching adaptive filters from the single channel adaptive filter to the multi-channel adaptive filter comprises restoring internal parameters relating to the multi-channel adaptive filter from a previous operation for switching adaptive filters from the multi-channel adaptive filter to the single channel adaptive filter.

In some examples, switching adaptive filters from the single channel adaptive filter to the multi-channel adaptive filter comprises copying, to each of a plurality of channels of the multi-channel adaptive filter, a filter based on a mono echo filter.

In some examples, switching adaptive filters from the single channel adaptive filter to the multi-channel adaptive filter further comprises initializing a multi-channel inverse correlation matrix using a diagonal matrix based on the inverse correlation matrix of the single channel adaptive filter.

In some examples, at least one of the first adaptive filter and the second adaptive filter comprises a frequency-domain adaptive filter.

In some examples, applying the second adaptive filter comprises applying a parallel adaptive filter for each frequency sub-band associated with the received audio signal.

In a third aspect, this specification describes an apparatus configured to perform any method as described with reference to the second aspect.

In a fourth aspect, this specification describes computer-readable instructions which, when executed by computing apparatus, cause the computing apparatus to perform any method as described with reference to the second aspect.

In a fifth aspect, this specification describes a computer program comprising instructions for causing an apparatus to perform at least the following: determining whether a received audio signal is associated with a single channel classification or a multi-channel classification; determining whether the received audio signal is associated with a different classification than a previous classification; switching adaptive filters for the received audio signal from a first adaptive filter to a second adaptive filter, based on the determination that the received audio signal is associated with a different classification than the previous classification; and applying the second adaptive filter to the received audio signal, wherein applying the second adaptive filter is configured to enable reduction of echo from a captured signal.

In a sixth aspect, this specification describes a computer-readable medium (such as a non-transitory computer-readable medium) comprising program instructions stored thereon for performing at least the following: determining whether a received audio signal is associated with a single channel classification or a multi-channel classification; determining whether the received audio signal is associated with a different classification than a previous classification; switching adaptive filters for the received audio signal from a first adaptive filter to a second adaptive filter, based on the determination that the received audio signal is associated with a different classification than the previous classification; and applying the second adaptive filter to the received audio signal, wherein applying the second adaptive filter is configured to enable reduction of echo from a captured signal.

In a seventh aspect, this specification describes an apparatus comprising: at least one processor; and at least one memory including computer program code which, when executed by the at least one processor, causes the apparatus to: determine whether a received audio signal is associated with a single channel classification or a multi-channel classification; determine whether the received audio signal is associated with a different classification than a previous classification; switch adaptive filters for the received audio signal from a first adaptive filter to a second adaptive filter, based on the determination that the received audio signal is associated with a different classification than the previous classification; and apply the second adaptive filter to the received audio signal, wherein applying the second adaptive filter is configured to enable reduction of echo from a captured signal.

In an eighth aspect, this specification describes an apparatus comprising: a first module configured to determine whether a received audio signal is associated with a single channel classification or a multi-channel classification; a second module configured to determine whether the received audio signal is associated with a different classification than a previous classification; a third module configured to switch adaptive filters for the received audio signal from a first adaptive filter to a second adaptive filter, based on the determination that the received audio signal is associated with a different classification than the previous classification; and a fourth module configured to apply the second adaptive filter to the received audio signal, wherein applying the second adaptive filter is configured to enable reduction of echo from a captured signal.

### BRIEF DESCRIPTION OF DRAWINGS

FIG. 1 is a block diagram of a system in accordance with an example embodiment;

FIG. 2 is a plot showing example signals;

FIG. 3 is a block diagram of a system in accordance with an example embodiment;

FIG. 4 is a flowchart of an algorithm in accordance with an example embodiment;

FIG. 5 is a block diagram of a system in accordance with an example embodiment;

FIGS. 6 to 10 are flowcharts of algorithms in accordance with example embodiments;

FIGS. 11 and 12 are example plots;

FIG. 13 is a block diagram of components of a system in accordance with an example embodiment; and

FIG. 14 shows an example of tangible media for storing computer-readable code which when run by a computer may perform methods according to example embodiments described above.

### DETAILED DESCRIPTION

The scope of protection sought for various example embodiments of the invention is set out by the independent claims. The embodiments and features, if any, described in the specification that do not fall under the scope of the independent claims are to be interpreted as examples useful for understanding various example embodiments of the invention.

In the description and drawings, like reference numerals refer to like elements throughout.

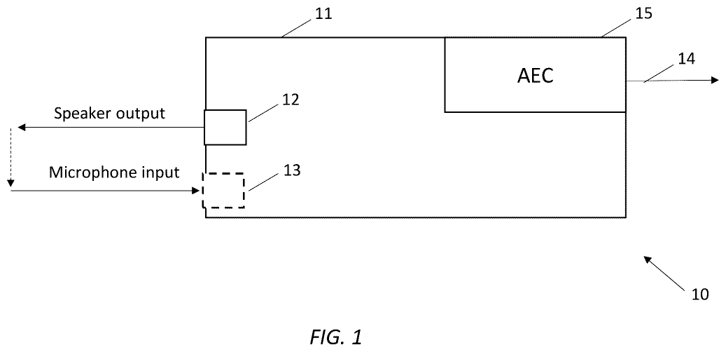

FIG. 1 shows a block diagram of a system, indicated generally by the reference numeral 10, in accordance with an example embodiment. The system 10 may comprise a device 11 which may comprise one or more speakers 12 (e.g. multi-channel speakers that may output multi-channel (e.g. stereo) audio signals or single channel (e.g. mono) audio signals), one or more microphones 13, and one or more acoustic echo cancellation modules 15. In one example, the device 11 may be a communications device which, for example, may be used for communicating audio with one or more other devices (e.g. in a video and/or audio call with a far end device, uploading and/or streaming audio and/or video content, sending audio and/or video content in a call or as a file, or the like). In such a communication session, the speaker(s) 12 may output audio signals for a user to hear, and the microphone(s) 13 may be configured to receive audio inputs, such as speech audio inputs from the user. However, the microphone(s) 13 may also detect audio output (e.g. playback audio signals) from the speaker(s) 12, which may cause an undesirable echo in the communication session. Such echoes may be reduced and/or cancelled by the acoustic echo cancellation (AEC) module 15, where the AEC module 15 may output a signal 14 which may comprise a processed microphone signal with reduced echo. For example, when using devices, such as the system 10 (e.g. in integrated hands-free (IHF) mode) for playing back audio with the built-in speakers (e.g. speakers 12) of the devices, a multi-channel acoustic echo cancellation (MCAEC) module may enable clearer communication by providing cancellation of acoustic echoes from more than one speaker on the device in the signal(s) recorded by the internal microphone(s) of the device. In some example embodiments, acoustic echo cancellation may be performed by applying an adaptive filter, which is described in further details below.

The techniques described herein may relate to enabling spatial audio communication and teleconferencing on mobile devices. When utilizing these devices in integrated hands-free (IHF) mode, i.e., playing back audio with the built-in speakers of the devices, multi-channel acoustic echo cancellation (MCAEC) may be required, which may be used for cancelling the acoustic echoes from more than one speaker on the device in the signal(s) recorded by the internal microphone(s) of the device. To perform acoustic echo cancellation (AEC) for multiple speakers, there is need for an adaptive filter that can handle multiple speaker signals. An example scenario may comprise a stereo playback so there are two speaker signals (called “reference signals” in AEC terminology) that need to be cancelled. Acoustic echo impulse responses may be relatively long compared with the sampling rate of audio systems, which may cause time-domain filter implementations to have high complexity (e.g. requiring thousands of taps). For this reason, AEC filters may be implemented via frequency-domain techniques such as filter banks and weighted overlap-add (WOLA), which may take advantage of the low complexity of the fast Fourier Transform. In such implementations, multiple adaptive filters are applied to every frequency bin in parallel.

An example use case may consist of spatial communication between mobile devices in IHF mode utilizing the Immersive Voice and Audio Services (IVAS) codec. In such a communication session, there may be stereo spatial rendering based on the metadata-assisted spatial audio (MASA) format. This may yield stereo playback signals which may be handled well by multi-channel AEC implementation.

However, when a far-end device in such a communication session is not supporting MASA (e.g. because of limited microphone capture capabilities), the stereo playback signal may be a dual mono signal. That is, the two channels may have identical signals or have the same signal in both channels with a different gain (including one gain being zero). In some scenarios, it may not be known in real time whether a signal is a stereo signal or a dual mono signal. For example, far end devices with single microphones may duplicate a mono capture signal for providing a multi-channel audio signal, or far end devices with multiple microphones may provide duplicated mono signals to a spatial audio codec. Further, a user may switch from a multi-channel audio capture device to a mono capture device (e.g. headset) during a call. However, most mobile devices may have at least two independent playback channels, which is why AEC for stereo playback signals is desirable.

In some scenarios with spatial teleconference calls (i.e., group calls) where every talker may be perceived virtually from any position via an app interface, direction of other talkers may be changed and their virtual position may be placed closer or far away, which may impact the level of reverberance in the spatial rendering. In some cases, the stereo playback signals may be rendered by filtering a mono capture with left and right head-related transfer functions (HRTFs), which may result in highly correlated signals for certain directions (like e.g. front direction). Consequently, the stereo playback signal may be close to a dual mono signal.

In some examples, the adaptive filters used for AEC implementation may be based on recursive least squares (RLS). RLS may have relatively fast convergence, and using frequency domain implementation may enable relatively low computational complexity. For AEC implementations using RLS, a plurality of short RLS filters may be applied for every frequency bin separately in parallel. To save additional CPU usage, the filters on higher frequency bins may use extra short filter lengths or use simplified RLS implementations. Furthermore, noise robust versions of an RLS algorithm may be used for improved performance under noisy conditions. RLS implementation may have ill-convergence issues in scenarios where a multi-channel signal is highly correlated (e.g. a plurality of duplicated mono signals). Such issues may relate to an inverse correlation matrix of the multi-channel signal which is updated and stored for every frequency bin by the RLS adaptation algorithm. Such issues may cause the RLS to stop working, and may require the system to be fully reset, which may be undesirable. Some example embodiments below aim to address such issues.

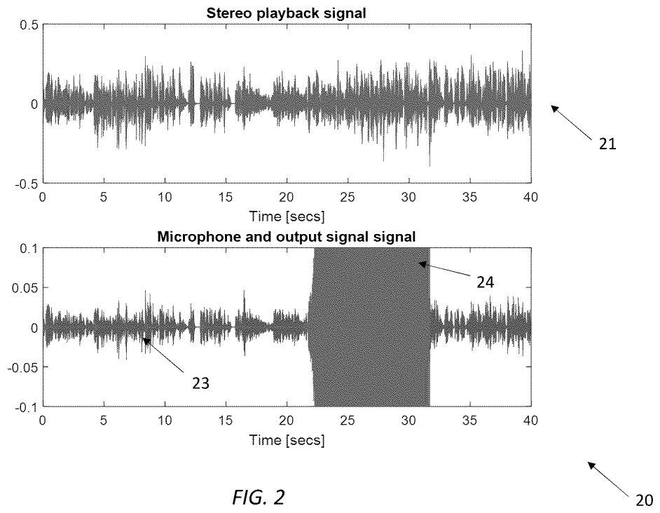

A problem may arise if RLS adaptive filters designed for multi-channel audio signals are applied to a plurality of mono signals, as detailed in the plots of FIG. 2.

FIG. 2 comprises plots, indicated generally by the reference numeral 20, showing example signals.

A plot 21 shows a plot for a multi-channel (e.g. stereo) playback signal (e.g. output from speaker 12) with respect to time. The speakers 12 may be multi-channel speakers that output multi-channel (e.g. stereo) audio signals, or plurality of single channel (identical mono) audio signals (e.g. dual mono signals that are identical to each other). It is possible for the stereo playback signal to change from a stereo signal to a dual mono signal from time to time, depending on the configuration of one or more far end devices (e.g. in a one-to-one call or a group-call). A different adaptive filter may be required for effective echo cancellation for multi-channel playback signal and for a plurality of single channel playback signals. Plot 22 shows a plot for a microphone signal 23 and an output signal 24. The output signal 24 may be an output from an echo cancellation module after having applied an adaptive filter. If it is assumed that the plot 21 consistently relates to a stereo signal, and an adaptive filter (e.g. an RLS adaptive filter) for stereo signals is applied accordingly, the output signal 24 may undesirably diverge to high levels, as shown between 15 to 25 seconds on the plot 22. For example, between 15 to 25 seconds, the stereo playback signal may suddenly change from a stereo signal to a dual mono signal, which may result in the output signal 24 to diverge to high levels and may cause filter coefficients to overflow.

It may be desirable for multi-channel acoustic echo cancellation to be robust against such changes (e.g. multi-channel signals changing to a plurality of identical signal channel signals).

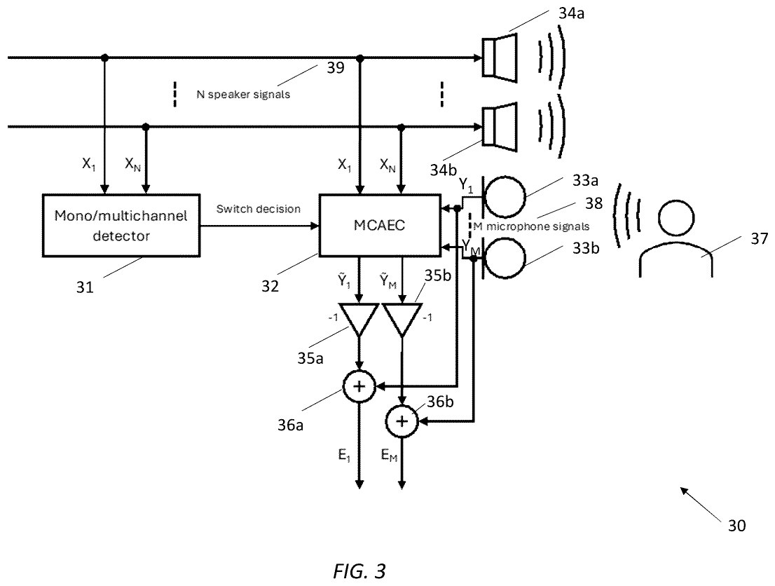

FIG. 3 is a block diagram of a system, indicated generally by the reference numeral 30, in accordance with an example embodiment. The system 30 comprises a detector module 31, an acoustic echo cancellation (AEC) module 32, one or more microphones 33 (33a, 33b), and multi-channel (loud) speakers 34 (34a, 34b). A user 37 may be in communication with a far end device (e.g. audio output generated from the speakers 34), where the microphones 33 (e.g. M number of microphones) may receive audio inputs 38 from the user, and may further receive audio signals 39 from the speakers 34. The microphones 33 may provide capture signals (Y₁ . . . Y_{M}) based on the received audio inputs 38 and received audio signals 39. The received audio signals 39 (X₁ . . . X_{N}) are further provided to the detector module 31, and the AEC module 32.

In an example embodiment, the detector module 31 determines whether an audio signal 39, such as the multi-channel playback signal, comprises a multi-channel (e.g. stereo) audio signal, or a plurality of single channel audio signals (e.g. duplicated mono audio signals with high correlation). The detector module 31 may then provide information of said determination to the AEC module 32, where an adaptive filter may be applied accordingly to an audio captured by the microphones 33.

In an example embodiment, output signal(s) (e.g. estimated echo signals at the microphone) from the AEC module 32 may be passed through modules 35 (35a, 35b) for applying inversions to the output signal(s), and may then be passed through modules 36 (36a, 36b) to compute an error signal using the selected adaptive filter.

In some examples, the error signals may be passed for further processing (e.g. noise reduction) and/or transmitted for communication to far end devices.

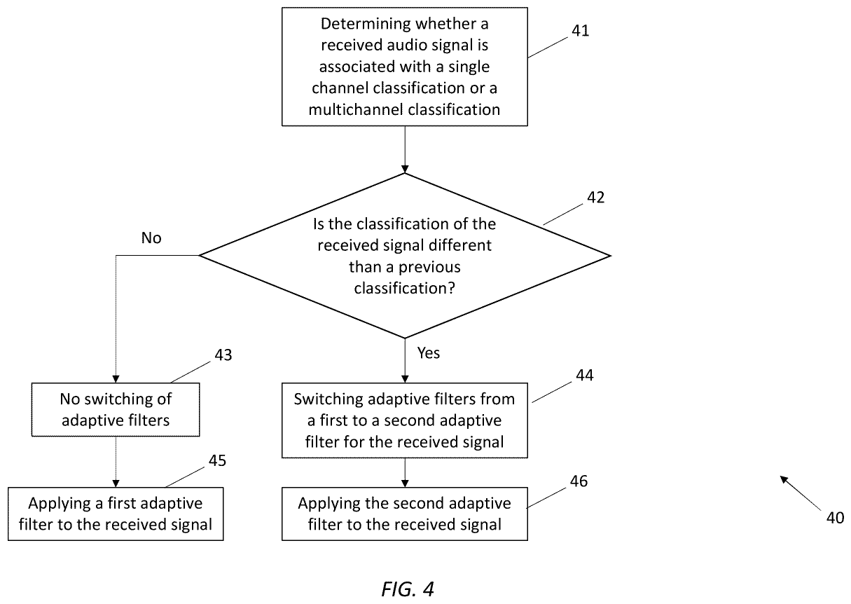

The operations of the system 30 is described in further detail with reference to FIG. 4.

FIG. 4 is a flowchart of an algorithm, indicated generally by the reference numeral 40, in accordance with an example embodiment.

The algorithm 40 may start at operation 41, where it is determined, for example by the detector module 31, whether a received audio signal (e.g. audio signals 39 received from a far end device during a communication session) is associated with a single channel classification or a multi-channel classification. For example, if the received audio signal comprises a multi-channel (e.g. stereo signal, it is determined that said received audio signal is associated with a multi-channel classification. Alternatively, if the received audio signal is determined to have a plurality of mono audio signals (e.g. signals with high correlation to each other), it is determined that the received audio signal is associated with a single channel classification. Examples of such mono audio signals may include multi-channel audio where all channels are identical, or scaled versions of each other.

Next, at operation 42, it is determined whether the received audio signal is associated with a different classification than a previous classification. In one example, the previous classification may relate to a classification that a previously received audio signal is associated with. Alternatively, or in addition, the previous classification may relate to a default or predefined classification. For example, the algorithm 40 may start with a default multi-channel classification, such that for an earliest received audio signal for a communication session, it may be determined whether a classification for the earliest received audio signal is different than a multi-channel classification. For subsequently received audio signals for said communication session, it may be determined whether a classification for said subsequently received audio signals is different than a classification for a previously received audio signal. In one example, the classification may be determined for a current signal frame (e.g. block of e.g. 20 ms) for the received audio signal, for the full band signal, or in frequency bands.

If it is determined that the received audio signal is associated with a different classification than a previous classification, the algorithm 40 may move to operation 44, where an adaptive filter for the received audio signal may be switched from a first adaptive filter to a second adaptive filter. The first adaptive filter may be associated with the previous classification, whereas the second adaptive filter may be associated with the classification of the received audio signal. Next, at operation 46, the second adaptive filter may be applied (e.g. at the AEC module 32) to the received audio signal, for example, to enable reduction of echo from a captured signal (e.g. audio inputs 38 captured by the microphones 33). In one example, the first adaptive filter and/or the second adaptive filter comprises a frequency domain adaptive filter. For frequency-domain or filter bank implementation of the RLS adaptive filters, the switching at operation 44 may be performed for all frequency bands together, or may be performed separately for each frequency band, or only for a specific frequency range. In an example embodiment, applying the second adaptive filter may comprise applying a parallel adaptive filter for each frequency sub-band associated with the received audio signal.

If it is determined, at operation 42 that the received audio signal is not associated with a different classification than a previous classification (e.g. classification of the received audio signal is same as the previous classification), the algorithm 40 may move to operation 43, where it is decided that no switching of adaptive filters need to be performed. Next, at operation 45, the first adaptive filter, associated with the previous classification as well as the classification of the received audio signal, is applied (e.g. at the AEC module 32) to the received audio signal, for example, to enable reduction of echo from the captured signal (e.g. audio inputs 38 captured by the microphones 33).

In an example embodiment, the first and second adaptive filters comprise recursive square filters.

The algorithm 40 allows detection of a multi-channel classification or a single channel classification of a received signal, such that a suitable adaptive filter can be applied accordingly in order to ensure that the issues relating to ill-convergence (e.g. arising from applying a multi-channel adaptive filter to an audio signal with single channel classification) may be prevented. As such, if an audio signal has a single channel classification, a single channel adaptive filter can be applied to said audio signal. The switching between adaptive filters may be relatively quick and seamless, such that users may not notice any interruption, as internal parameters for the first adaptive filter may be usable for applying the second adaptive filter, which will be discussed in further detail below. Furthermore, switching between adaptive filters (e.g. as performed in operation 44) enables use of minimal time and computing resources and may therefore enable enhanced battery life. For example, using a single channel adaptive filter for a monaural playback signal may save resources when compared to using a multi-channel adaptive filter. By switching between adaptive filters only a single AEC module is active at a given time instance.

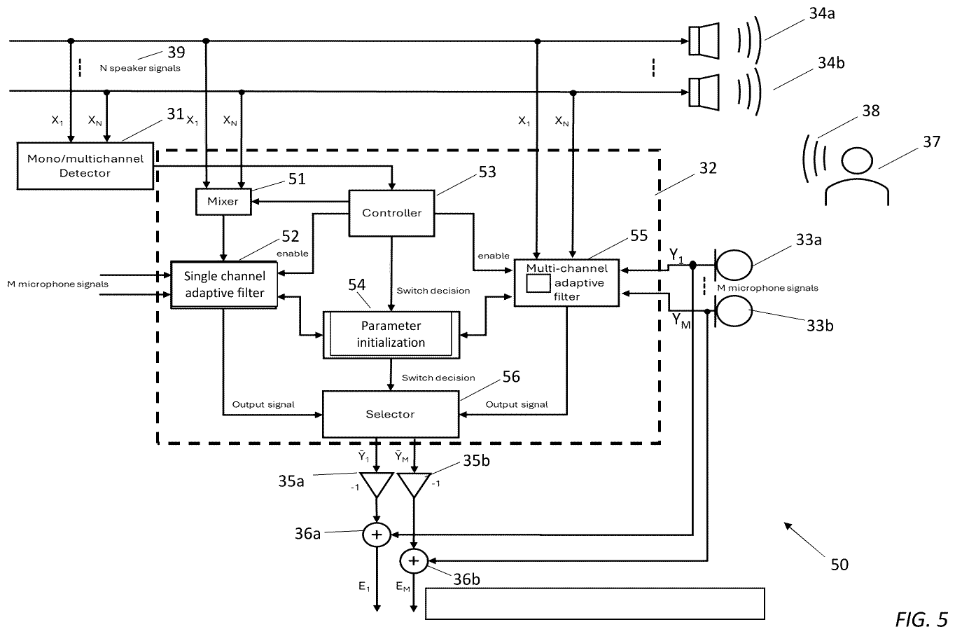

FIG. 5 is a block diagram of a system, indicated generally by the reference numeral 50, in accordance with an example embodiment.

System 50 comprises the elements of system 30, and further shows components of the AEC module 32. For example, the AEC module 32 may comprise a mixer module 51, a single channel adaptive filter module 52, a controller 53, a parameters initialization module 54, a multi-channel adaptive filter module 55, and a selector module 56.

For example, the detector module 31 may provide information to the controller 53 of whether the received audio signal 39 is associated with a multi-channel classification or a single channel classification. Based on said information, the controller 53 may enable the single channel adaptive filter module 52 (if the received audio signal 39 is associated with a single channel classification) and/or may enable the multi-channel adaptive filter module 55 (if the received audio signal 39 is associated with a multi-channel classification). The single channel adaptive filter module 52 may apply a single channel adaptive filter to audio signals 39 (e.g. either one of the plurality of audio signals 39, or a mix of the plurality of audio signals 39 received from the mixer module 51), and output a single channel filtered signal. The multi-channel adaptive filter module 55 may apply a multi-channel adaptive filter to audio signals 39, and output a multi-channel filtered signal. The single channel filtered signal and/or the multi-channel filtered signal may further be based on the microphone signals received from microphones 33 provided to the single channel adaptive filter module 52 and/or the multi-channel adaptive filter module 55 respectively. The controller 53 may further provide a switch decision (e.g. whether to switch adaptive filters from the first adaptive filter to the second adaptive filter) to the parameters initialization module 54. The parameters initialization module 54 may be used for extracting internal parameters of the first adaptive filter, and may further be used for determining internal parameters of the second adaptive filter based at least partially on the internal parameters of the first adaptive filter. The switch decision may then further be provided to the selector module 56, which then selects either the single channel output signal from the single channel adaptive filter module 52 or the multi-channel output signal from the multi-channel adaptive filter module 55. The selected channel may then be passed through the modules 35 and 36.

In some examples, an adaptive filter using recursive least squares algorithm may consider the following criteria for each frequency bin:
Microphone signal yₙ at frame n
Multi-channel playback signal

$${x}_{n} = [ {x}_{n}^{1} ; {x}_{n}^{S} ]$$

with xₙ of length L and S the number of playback channels

$${w}_{n} = ( {w}_{n}^{1} ; {w}_{n}^{S} )$$

is the echo filter of L taps at frame n

$${e}_{n} = {y}_{n} - {w}_{n}^{T} {x}_{n}$$

is the prior error signal computed using the current echo filter at the frame n.

$${e}_{n}^{post} = {y}_{n} - {w}_{n + 1}^{T} {x}_{n}$$

the posterior error signal, computed using the adapted echo filter.
Cₙ is the inverse correlation matrix at frame n corresponding the RLS adaptive filter. It is thus the inverse of the speaker correlation matrix with exponential weighting λ, also known as the forgetting factor

$${C}_{n} = {R}_{n}^{- 1} with {R}_{n} = {\sum }_{i = 0}^{n} {λ}^{n - i} {x}_{i} {x}_{i}^{H}$$

RLS adaptive filters store and update the inverse correlation matrix Cₙ for every frame and frequency bin.

It would be appreciated that the equations in the above example relate to a single microphone signal; however, the equations can be applied to a plurality of microphones (e.g. M microphone signals) by having a plurality of (M) echo filters and a plurality of (M) output signals).

An example RLS adaptation of echo filter is shown below.
Initialize RLS algorithm at startup for every frequency bin C₀=δ⁻¹I_{L}, δ is a small constant

$${w}_{0} = {0}_{L}$$

For every frame n=1,2, . . . perform:

$${e}_{n} = {y}_{n} - {w}_{n}^{T} {x}_{n}$$

$${v}_{n} = {C}_{n - 1} {x}_{n}$$

$${δ}_{n}^{2} = {v}_{n}^{H} {x}_{n} + λ$$

$${q}_{n} = \frac{1}{{δ}_{n}^{2}} {v}_{n}$$

$${Y}_{n}^{2} = \frac{1}{{δ}_{n}^{2}}$$

$${C}_{n} = ( \frac{1}{λ} {C}_{n - 1} - {q}_{n} {x}_{n}^{H} {C}_{n - 1} )$$

$${w}_{n + 1} = {w}_{n} + {q}_{n} {e}_{n}^{*}$$

$${e}_{n}^{post} = {γ}_{n}^{2} {e}_{n}$$

In some examples, regularization terms may be added in update formulas based on prior error information in order to improve robustness against noise. It would be appreciated that many variants of RLS adaption algorithms may exist. The example embodiments may apply to any variant that may use inverse correlation matrices.

In some examples, the single channel adaptive filter and the multi-channel adaptive filter may be different in the number of audio channels that are provided as inputs to an adaptation algorithm. For example, for a single channel adaptive filter, a plurality of mono audio signals may be mixed or combined into a single audio channel which is then provided as an input to the adaptation algorithm (single channel adaptive filter module 52) for applying the single channel adaptive filter. Alternatively, for a multi-channel adaptive filter, a plurality of channels of the multi-channel audio signal may be provided (without mixing or combining) as inputs to the adaptation algorithm (multi-channel adaptive filter module 55) for applying the multi-channel adaptive filter.

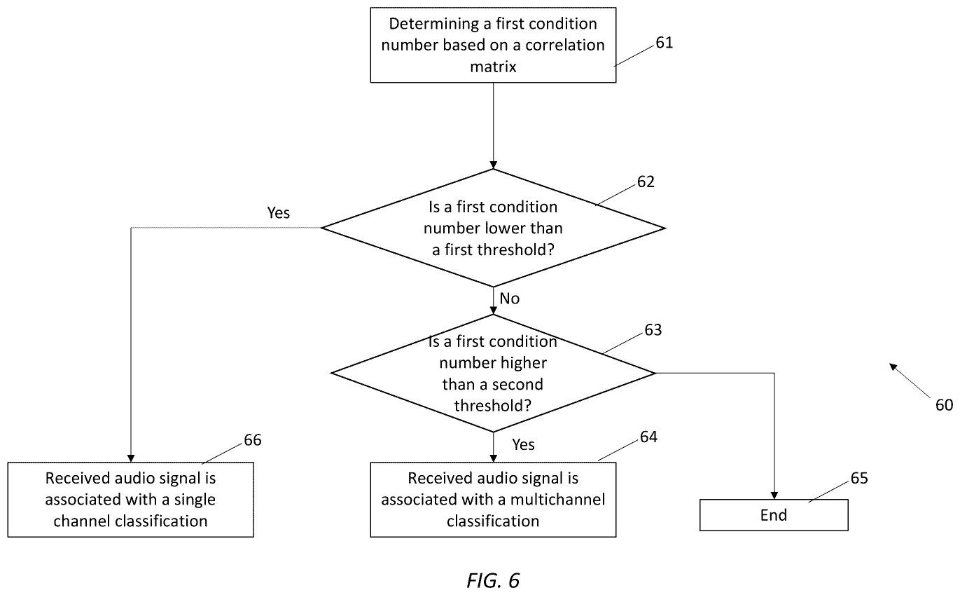

FIG. 6 is a flowchart of an algorithm, indicated generally by the reference numeral 60, in accordance with an example embodiment. The algorithm 60 may be used for determining (e.g. as an example implementation of operation 41) whether a received audio signal is associated with a single channel classification or a multi-channel classification.

At operation 61, a condition number may be determined based, at least in part, on a correlation matrix (R) associated with the received audio signal. For example, the condition number may be calculated as a ratio of a largest singular value and a smallest singular value of a singular value decomposition, for example, based on the correlation matrix (R). For example, the condition number may be a 2-norm condition number. Alternatively, or in addition, any p-norm condition number may be used, with p being in range 1 to infinity.

Next, at operation 62, it is determined whether the condition number is lower than a first threshold. If the condition number is determined to be lower than the first threshold, the algorithm 60 moves to operation 66, where it may be determined that the audio signal is associated with a single channel classification. If the condition number is not lower than the first threshold, the algorithm 60 may move to the operation 63.

At operation 63, it is determined whether the condition number is higher than a second threshold. If the condition number is determined to be higher than the second threshold, the algorithm 60 moves to operation 64, where it may be determined that the audio signal is associated with a multi-channel classification. If the condition number is not higher than the second threshold, the algorithm 60 may end at the operation 65 and there is no switch decision.

In some example embodiments, the determination of whether a received audio signal is associated with a single channel classification or a multi-channel classification may be performed by tracking a time-domain 2×2 correlation matrix R^{time} of the stereo playback signals as follows:

$${R}^{t} = E \{ {x}_{t}^{time} {x}_{t}^{time , T} \} ,$$

where

$${x}_{n}^{time} = \{ {x}_{1} ( t ) ; {x}_{S} ( t ) \}$$

is a Sx1 time-domain speaker vector for time step t with a plurality of channels of the audio signal (e.g. left and right channel of a stereo audio signal) cascaded. R^{t} may be estimated for every frame n by averaging all time samples in frame n of length M:

$${R}_{n} = \frac{1}{M} {\sum }_{t = n M}^{n M + M - 1} {x}_{t}^{time} {x}_{t}^{time , T}$$

In some examples, Rₙ may be computed based on exponential moving average. In some examples, the correlation matrix for frame n may also be averaged with the correlation matrix of previous frames.

In some examples for a stereo speaker signal, a correlation value between the left and right time-domain channel may be computed instead of the condition number of the correlation matrix. This correlation value may be used to determine whether a received audio signal is associated with a single channel classification or a stereo channel classification.

In some examples, single channel or multi-channel detection may also be performed based on per-frequency bin (or groups of bins). For example, a correlation matrix for every bin (or group of bins) may be tracked after time-to-frequency transformation. Moreover, the magnitude squared coherence may also be easily tracked instead of the condition number of the correlation matrix.

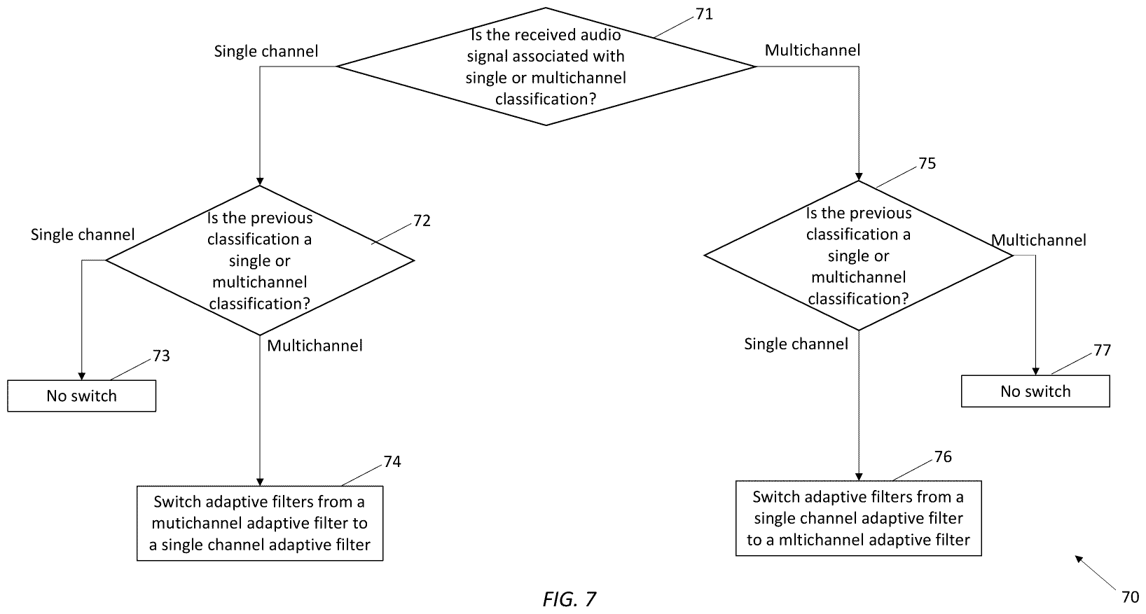

FIG. 7 is a flowchart of an algorithm, indicated generally by the reference numeral 70, in accordance with an example embodiment.

At operation 71, it is determined whether a received audio signal is associated with a single or multi-channel classification. If the received audio signal is considered to be associated with a single channel classification, the algorithm 70 moves to operation 72, where it is determined whether a previous classification (e.g. a default classification or a classification of a previously received audio signal) is a single or a multi-channel classification. If the previous classification is also a single channel classification, adaptive filters may not be switched, as shown in operation 73. If the previous classification is a multi-channel classification, the algorithm 70 may move to operation 74, where adaptive filters may be switched from a multi-channel adaptive filter to a single channel adaptive filter.

Alternatively, if the received audio signal is considered to be associated with a multi-channel classification, the algorithm 70 moves to operation 75, where it is determined whether a previous classification (e.g. a default classification or a classification of a previously received audio signal) is a single or a multi-channel classification. If the previous classification is also a multi-channel channel classification, adaptive filters may not be switched, as shown in operation 77. If the previous classification is a single channel classification, the algorithm 70 moves to the operation 76, where adaptive filters may be switched from a single channel adaptive filter to a multi-channel adaptive filter.

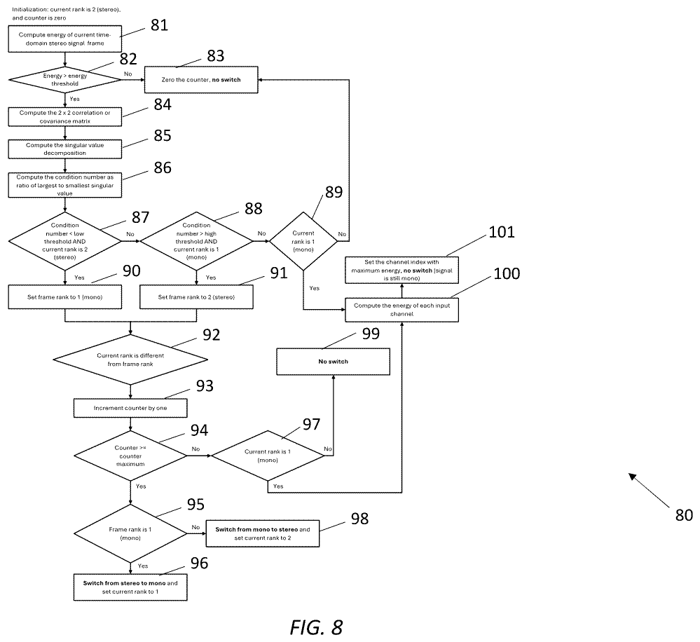

FIG. 8 is a flowchart of an algorithm, indicated generally by a reference numeral 80, in accordance with an example embodiment. The algorithm 80 may be an example of how it is determined whether to switch adaptive filters or not.

The algorithm 80 may start after an initialization where a default classification may be set as multi-channel classification. For example, a current rank may be set at 2 (e.g. stereo) and a counter may be set to zero. The terms ‘stereo’ and ‘multi-channel’ may be used interchangeably in FIG. 8, such that the term ‘stereo’ may indicate two or more channels.

At operation 81, energy of a received audio signal (e.g. time domain stereo signal frame) may be determined. If the energy is determined to be lower than an energy threshold at operation 82, the counter may be set to zero at operation 83, and switching of adaptive filters is not performed.

If the energy is determined to be higher than an energy threshold at operation 82, a correlation or covariance matrix (e.g. 2×2 matrix) associated with the received audio signal may be computed at operation 84. Next, at operation 85, a singular value decomposition may be computed for the correlation matrix. At operation 86, a condition number may be computed (e.g. similar to operation 61) as a ratio of a largest singular value to smallest singular value.

If it is determined, at operation 87, that the condition number is lower than a first threshold, and the current rank is ‘2’ (e.g. default stereo classification as part of initialization and/or previous stereo classification of a previously received audio signal), a frame rank is set to ‘1’ (mono classification) at operation 90. The frame rank may represent the classification of the received audio signal. Alternatively, if it is determined at operation 87 that the condition number is not lower than the first threshold or that the current rank is not ‘2’, the algorithm 80 may move to operation 88, where it is determined whether the condition number is higher than a second threshold and a current rank is ‘1’ (e.g. default mono classification as part of initialization and/or previous mono classification of a previously received audio signal), the frame rank is set to ‘2’ (e.g. multi-channel or stereo) at operation 91.

Alternatively, if the condition number is not higher than the second threshold or if the current rank is not ‘1’, it is determined whether the current rank is ‘1’ at operation 89, and if it is determined that the current rank is not ‘1’, the algorithm 80 may move to operation 83 and zero the counter, and switching of adaptive filters may not be performed. If the current rank is ‘1’, the algorithm 80 may move to operation 100, where the energy of each input channel is computed, and a channel index may be set with maximum energy at operation 101, and no switching of adaptive filters is performed.

After operation 90 and/or 91, operation 92 may be performed to determine whether the current rank (previous classification) is different from the frame rank (classification of received audio signal). If the current rank is different from the frame rank, the counter may be incremented by one at operation 93. If the counter is determined to be less than a counter maximum at operation 94, and a current rank is determined to be ‘2’ at operation 97, the algorithm 80 may move to operation 99 and no switching of adaptive filters is performed. If the counter is determined to be less than or equal to a counter maximum at operation 94, and a current rank is determined to be ‘1’ at operation 97, the algorithm 80 may move to operation 100 where the energy of each input channel is computed, and a channel index may be set with maximum energy at operation 101, and no switching of adaptive filters is performed.

If the counter is determined to be more than or equal to a counter maximum at operation 94, and a frame rank is determined to be ‘1’ at operation 95, the algorithm 80 may move to operation 96 for switching from multi-channel (stereo) adaptive filter to a single channel adaptive filter, and the current rank is set to ‘1’. If frame rank is determined to be ‘2’ at operation 95, the algorithm 80 may move to operation 98 for switching from single channel (mono) adaptive filter to a multi-channel adaptive filter, and the current rank is set to ‘2’.

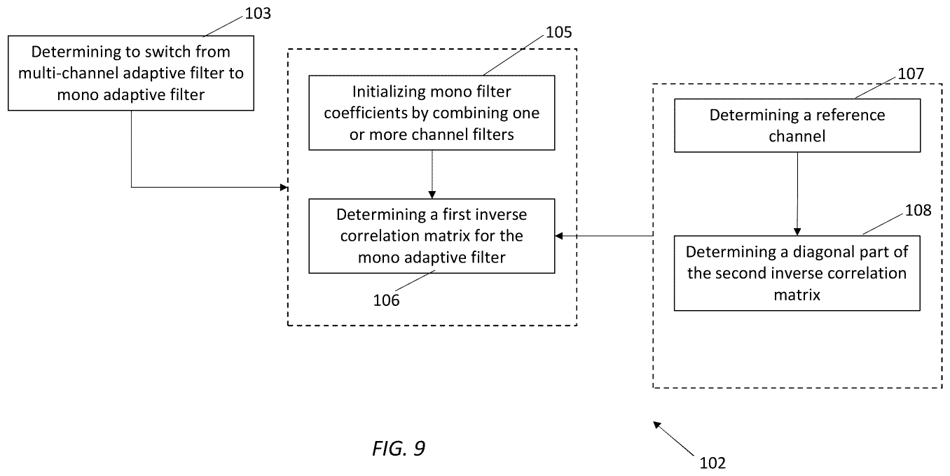

FIG. 9 is a flowchart of an algorithm, indicated generally by the reference numeral 102, in accordance with an example embodiment.

The algorithm 102 may start at operation 103, where it is determined to switch from multi-channel adaptive filter to a single channel adaptive filter. Switching adaptive filters from the multi-channel adaptive filter to the single channel adaptive filter may comprises initializing, at operation 105, mono filter coefficients by combining ne or more channel filters of the multi-channel adaptive filter. Next, at operation 106, a first inverse correlation matrix for the single channel adaptive filter may be determined based, at least in part, on a second inverse correlation matrix for the multi-channel adaptive filter corresponding to at least one of a plurality of channels of the received audio signal. As such, internal parameters (e.g. including first inverse correlation matrix) of the single channel adaptive filter may be determined, at least in part, on internal parameters (e.g. including second inverse correlation matrix) of the multi-channel adaptive filter. This may allow the switching of adaptive filters to be relatively quick (fast re-convergence) and require relatively low resources (low complexity).

In one example, the determining of the first inverse correlation matrix may comprise determining, at operation 107, a reference channel. The reference channel may be determined based on mixing (e.g. averaging) of a plurality of channels of the received audio signal. Alternatively, the reference channel may be determined based on selecting a channel having a highest energy from a plurality of channels of the received audio signal. In some examples, the combining of one or more channel filters (e.g. in operation 105) may be based on the determined reference channel.

In one example, the determining of the first inverse correlation matrix may further be based, at least in part, on determining, at operation 108, a diagonal part of the second inverse correlation matrix for the multi-channel adaptive filter corresponding to a reference channel.

An example implementation of the algorithm 102 may be as follows.

For example, a stereo (e.g. multi-channel) recursive least squares (RLS) may be in effect when a playback signal (e.g. received audio signal) changes from stereo to mono classification. A mixer module (e.g. mixer 31) may select a left channel (e.g. one of a plurality of signals of a multi-channel audio signal) as reference signal. Mono filter coefficients (single channel adaptive filter coefficients) may be initialized by combining the stereo filters, for instance as follows:

$${w}^{mono} = {w}_{stereo}^{left} + {w}_{stereo}^{right}$$

An inverse correlation matrix C (e.g. first inverse correlation matrix) for the mono adaptive filter may be derived from the stereo inverse correlation matrix as follows:

$${R}_{stereo} = [ \begin{matrix}{R}_{11} & {R}_{12} \\ {R}_{21} & {R}_{22}\end{matrix} ] = inv ( {C}_{stereo} )$$

$${R}_{mono} = {R}_{11}$$

$${C}_{mono} = inv ( {R}_{mono} )$$

Where R₁₁ is the upper left L/2 by L/2 block of,, corresponding to the left channel. When, for example, the reference channel corresponds to the average of the left and right audio channels, R may be derived as:

$${R}_{m o n o} = \frac{1}{2} ( {R}_{11} + {R}_{22} ) .$$

In some examples, complexity may be lowered by only using the diagonal part of Cₛₜₑᵣₑₒ that corresponds to the left channel. That is, the inverse correlation matrix for the mono adaptive filter may be approximated by a diagonal matrix, as follows:

$${C}_{mono} = diag ( \vert {C}_{stereo}^{11} \vert ) , where {C}_{stereo}^{11}$$

is the upper left L/2 by L/2 block of Cₛₜₑᵣₑₒ corresponding to the left channel. That is, the absolute values of the diagonal elements of

$${C}_{stereo}^{11}$$

are used to construct a diagonal matrix Cₘₒₙₒ.

Using internal parameters of the stereo adaptive filters for the mono adaptive filters may enable a relatively fast convergence of mono RLS after a switch event. This may ensure that both the filter coefficients and the inverse correlation matrices are initialized close to the optimal values. In contrast, when doing a blind start for RLS with default inverse correlation matrix initialization, it may take a few seconds (e.g. 1 to 3 seconds) before the filter and the inverse correlation matrix are fully converged, which may lead to a longer echo glitch to be observed, which may be undesirable. The example embodiments above provide significant improvements when compared to blind mono RLS initialization.

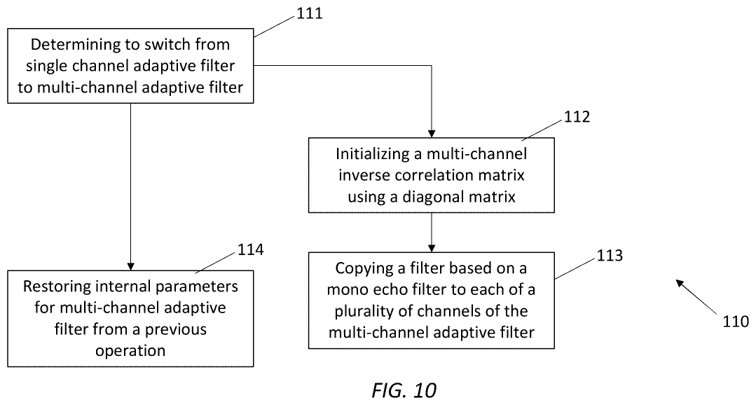

FIG. 10 is a flowchart of an algorithm, indicated generally by the reference numeral 110, in accordance with an example embodiment. The algorithm 110 may describe an example of switching from a single channel adaptive filter to a multi-channel adaptive filter.

The algorithm 110 may start at operation 111, where it is determined to switch from a single channel adaptive filter to a multi-channel adaptive filter.

In one example, the switching may comprise performing operation 114 for restoring internal parameters relating to the multi-channel adaptive filter from a previous operation for switching adaptive filters from the multi-channel adaptive filter to the single channel adaptive filter.

Alternatively, or in addition, the switching may comprise performing operation 112 for initializing a stereo inverse correlation matrix using a diagonal matrix based on the inverse correlation matrix of the single channel adaptive filter. Next, at operation 113, a filter, based on a mono echo filter may be copied to each of a plurality of channels of the multi-channel adaptive filter. The filter may be the mono echo filter divided by at least a number (N) of the plurality of channels of the received audio signal. For example, the multi-channel (e.g. stereo) inverse correlation matrix can be initialized with a diagonal matrix as follows:

$${C}_{stereo} = diag ( \begin{matrix}\vert {C}_{mono} \vert & 0 \\ 0 & \vert {C}_{mono} \vert\end{matrix} )$$

In another example, the multi-channel (e.g. stereo) inverse correlation matrix may be initialized with a diagonal matrix as follows:

$${C}_{stereo} = diag ( \frac{1}{E \{ {\vert {x}_{1} \vert}^{2} \}} , … , \frac{1}{E \{ {\vert {x}_{L} \vert}^{2} \}} ) ,$$

Where E(|xₗ|²) is the expected input power of the l-th tap of the stereo filter, which are readily available.

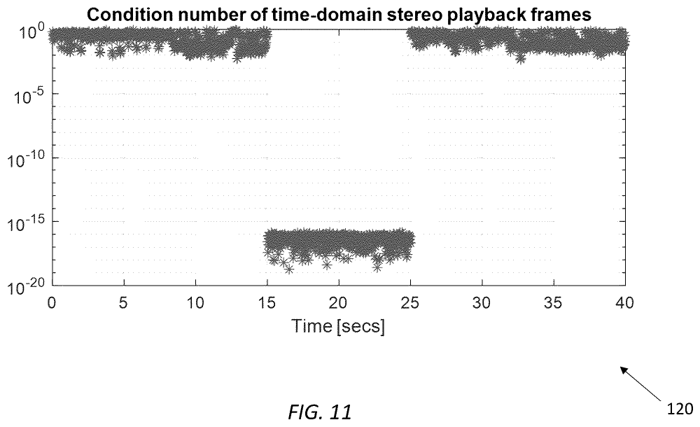

FIG. 11 shows a plot, indicated generally by the reference numeral 120, in accordance with an example embodiment. The plot 120 shows an illustration of a condition number (e.g. as determined in operations 61 and 86, with respect to time) associated with time-domain stereo playback frames. Between 15 and 20 seconds, the stereo playback signal may suddenly change from a stereo signal to a dual mono signal (e.g. as shown in the plot 21 described with reference to FIG. 2; if adaptive filters are not switched, this may result in the output signal to diverge to high levels and may cause filter coefficients to overflow for RLS adaptive filters in particular). However, as shown in plot 120, it is clear from the condition number whether a received audio signal has a multi-channel classification or a single channel classification (15 to 20 seconds, where the condition number is low, e.g. lower than a first threshold). As such, since the condition number clearly shows the switching between classification, the algorithms described above may be implemented to seamlessly switch between multi-channel and single channel adaptive filters accordingly.

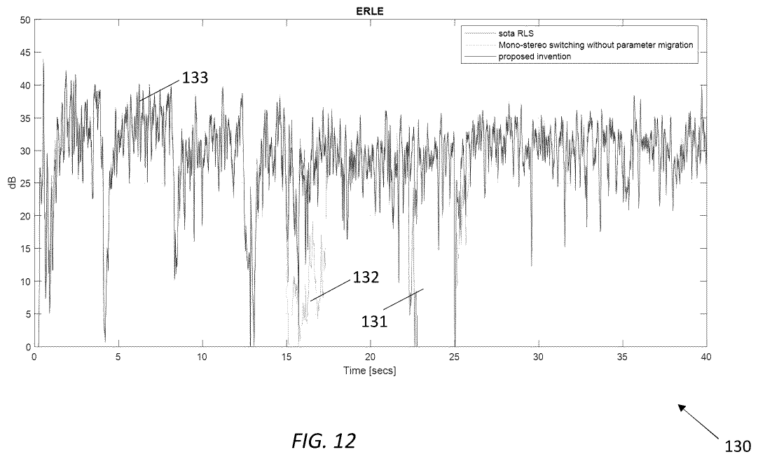

FIG. 12 shows a plot, indicated generally by the reference numeral 130, in accordance with an example embodiment. The plot 130 shows an example first filter ERLE (echo return loss enhancement) plot 131 (consistently using stereo adaptive RLS filter), a second filter ERLE plot 132 (switching between mono and stereo adaptive RLS filters when needed, but not utilizing internal parameters of an adaptive filter corresponding to previous classification), and a third filter ERLE plot 133 (switching between mono and stereo adaptive RLS filters when needed, while also utilizing internal parameters of an adaptive filter corresponding to a previous classification). It can be seen that the plot 133, which shows an example implementation of the example embodiments above (e.g. FIG. 4 algorithm), shows relatively better ERLE results than plots 131 or 132. The ERLE plot 131 drops to negative values after 23 seconds because the RLS filter diverges.

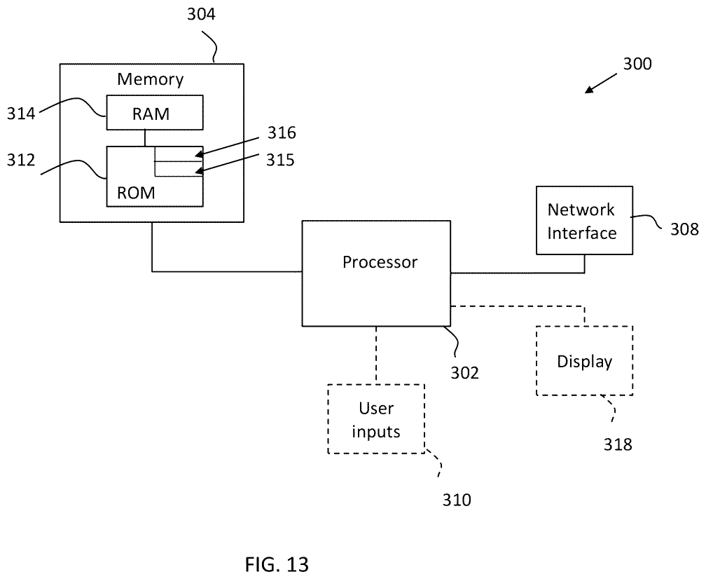

For completeness, FIG. 13 is a schematic diagram of components of one or more of the example embodiments described previously, which hereafter are referred to generically as processing systems 300. A processing system 300 may have a processor 302, a memory 304 closely coupled to the processor and comprised of a RAM 314 and ROM 312, and, optionally, user input 310 and a display 318. The processing system 300 may comprise one or more network/apparatus interfaces 308 for connection to a network/apparatus, e.g. a modem which may be wired or wireless. Interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid-state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain computer program code which, when executed by the processor implements aspects of the algorithms 40, 60, 70, 80, 102, 110, described above. Note that in the case of small device/apparatus the memory can be most suitable for small size usage i.e. not always hard disk drive (HDD) or solid-state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

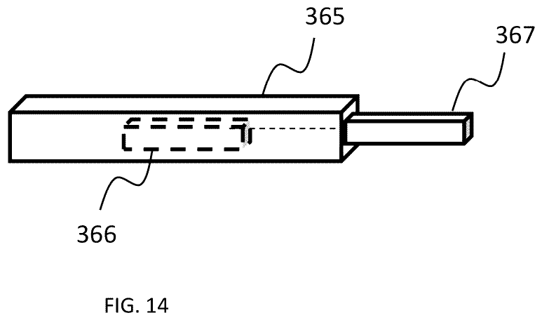

FIG. 14 shows tangible media, specifically a removable memory unit 365, storing computer-readable code which when run by a computer may perform methods according to example embodiments described above. The removable memory unit 365 may be a memory stick, e.g. a USB memory stick, having internal memory 366 for storing the computer-readable code. The internal memory 366 may be accessed by a computer system via a connector 367. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialized circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

As used in this application, the term “circuitry” refers to all of the following: (a) hardware-only circuit implementations (such as implementations in only analogue and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a server, to perform various functions) and (c) to circuits, such as a microprocessor(s) or a portion of a microprocessor(s), that require software or firmware for operation, even if the software or firmware is not physically present.

If desired, the different functions discussed herein may be performed in a different order and/or concurrently with each other. Furthermore, if desired, one or more of the above-described functions may be optional or may be combined. Similarly, it will also be appreciated that the flow charts of FIGS. 4, and 6 to 10, are examples only and that various operations depicted therein may be omitted, reordered and/or combined.

It will be appreciated that the above-described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1-20. (canceled)

21. An apparatus comprising:
at least one processor; and
at least one memory storing instructions that, when executed by the at least one processor, cause the apparatus at least to:
determine whether a received audio signal is associated with a single channel classification or a multi-channel classification;
determine whether the received audio signal is associated with a different classification than a previous classification;
switch adaptive filters for the received audio signal from a first adaptive filter to a second adaptive filter, based on the determination that the received audio signal is associated with the different classification than the previous classification; and
apply the second adaptive filter to the received audio signal, wherein the applying the second adaptive filter enables reduction of echo from a captured signal.

22. An apparatus as claimed in claim 21, wherein the first adaptive filter and the second adaptive filter comprise recursive least squares filters.

23. An apparatus as claimed in claim 21, wherein switching comprises determining internal parameters of the second adaptive filter based, at least in part, on internal parameters of the first adaptive filter.

24. An apparatus as claimed in claim 21, wherein determining whether the received audio signal is associated with the single channel classification or the multi- channel classification comprises:
determining that the received audio signal is associated with the single channel classification when a condition number is lower than a first threshold; and
determining that the received audio signal is associated with the multi-channel classification when the condition number is higher than a second threshold, wherein the condition number is calculated based on a correlation matrix associated with the received audio signal.

25. An apparatus as claimed in claim 21, wherein the multi-channel classification indicates a stereo classification, and the single channel classification indicates a mono classification.

26. An apparatus as claimed in claim 21, wherein switching adaptive filters comprises switching adaptive filters from a multi-channel adaptive filter to a single channel adaptive filter when the received audio signal is associated with the single channel classification and the previous classification is the multi-channel classification.

27. An apparatus as claimed in claim 26, wherein switching adaptive filters from the multi-channel adaptive filter to the single channel adaptive filter comprises:
initializing mono filter coefficients by combining one or more channel filters of the multi-channel adaptive filter.

28. An apparatus as claimed in claim 26, wherein switching adaptive filters from the multi-channel adaptive filter to the single channel adaptive filter comprises:
determining a first inverse correlation matrix for the single channel adaptive filter based, at least in part, on a second inverse correlation matrix for the multi-channel adaptive filter corresponding to at least one of:
at least one of a plurality of channels of the received audio signal; or
a reference channel of the plurality of channels of the received audio signal.

29. An apparatus as claimed in claim 28, wherein the first inverse correlation matrix is determined based, at least in part, on a diagonal part of the second inverse correlation matrix for the multi-channel adaptive filter corresponding to the reference channel.

30. An apparatus as claimed in claim 28, wherein the apparatus is further caused to determine the reference channel based on mixing of the plurality of channels of the received audio signal.

31. An apparatus as claimed in claim 29, wherein the apparatus is further caused to determine the reference channel based on selecting a channel having a highest energy from the plurality of channels of the received audio signal.

32. An apparatus as claimed in claim 21, wherein switching adaptive filters comprises switching adaptive filters from a single channel adaptive filter to a multi-channel adaptive filter when the received audio signal is associated with the multi-channel classification and the previous classification is the single channel classification.

33. An apparatus as claimed in claim 32, wherein switching adaptive filters from the single channel adaptive filter to the multi-channel adaptive filter comprises restoring internal parameters relating to the multi-channel adaptive filter from a previous operation for switching adaptive filters from the multi-channel adaptive filter to the single channel adaptive filter.

34. An apparatus as claimed in claim 32, wherein switching adaptive filters from the single channel adaptive filter to the multi-channel adaptive filter comprises copying, to each of a plurality of channels of the multi-channel adaptive filter, a filter based on a mono echo filter.

35. An apparatus as claimed in claim 32, wherein switching adaptive filters from the single channel adaptive filter to the multi-channel adaptive filter further comprises initializing a multi-channel inverse correlation matrix using a diagonal matrix based on inverse correlation matrix of the single channel adaptive filter.

36. An apparatus as claimed in claim 21, wherein at least one of the first adaptive filter and the second adaptive filter comprises a frequency-domain adaptive filter.

37. An apparatus as claimed in claim 36, wherein applying the second adaptive filter comprises applying a parallel adaptive filter for each frequency sub-band associated with the received audio signal.

38. A method comprising:
determining whether a received audio signal is associated with a single channel
classification or a multi-channel classification;
determining whether the received audio signal is associated with a different classification than a previous classification;
switching adaptive filters for the received audio signal from a first adaptive filter to a second adaptive filter, based on the determination that the received audio signal is associated with the different classification than the previous classification; and
applying the second adaptive filter to the received audio signal, wherein applying the second adaptive filter enables reduction of echo from a captured signal.

39. A non-transitory computer readable medium comprising program instructions stored thereon for performing at least the following:
determine whether a received audio signal is associated with a single channel classification or a multi-channel classification;
determine whether the received audio signal is associated with a different classification than a previous classification;
switch adaptive filters for the received audio signal from a first adaptive filter to a second adaptive filter, based on the determination that the received audio signal is associated with the different classification than the previous classification; and
apply the second adaptive filter to the received audio signal, wherein applying the second adaptive filter enables reduction of echo from a captured signal.
